(19) United States
(12) Patent Application Publication
(10) Pub. No.: US 2015/0334067 A1
(43) Pub. Date: Nov. 19, 2015

(54) MESSAGING PROVIDING GRAPHICAL AND AUDIBLE FEATURES

(71) Applicant: GNOTECH LLC, Madison, WI (US)

(72) Inventor: Lark Zonka, Madison, WI (US)

(21) Appl. No.: 14/654,340

(22) PCT Filed: Dec. 20, 2013
(86) PCT No.: PCT/US13/77125

§ 371 Date: Jun. 19, 2015

Related U.S. Application Data
(60) Provisional application No. 61/740,739, filed on Dec. 21, 2012.

(51) Int. Cl. H04L 12/58; G06F 3/0481; G06F 3/0482; H04L 29/08; G06F 3/0484

(52) U.S. Cl. CPC H04L 51/10; H04L 67/10; G06F 3/04842; G06F 3/0482; G06F 3/04817; H04L 51/02

(57) ABSTRACT

Methods and systems for messaging. One system includes a first computing device that includes a first processor and first non-transitory computer-readable medium. The first computer-readable medium stores a first software application executable by the first processor to receive a selection of an audio-enabled emoticon from a first user, automatically insert at least one tag into a message wherein the at least one tag is associated with the selected audio-enabled emoticon, and transmit the message to a second computing device including a second processor and second non-transitory computer-readable medium. The second computer-readable medium stores a second software application executable by the second processor to translate the at least one tag into the selected audio-enabled emoticon and display the selected audio-enabled emoticon as part of the message to a second user.

### RELATED APPLICATIONS

This application claims priority to U.S. Provisional Application No. 61/740,739, filed Dec. 21, 2012, the entire content of which is hereby incorporated by reference.

### FIELD

This invention relates to mobile messaging and, in particular, relates to mobile text messaging that enables senders to incorporate graphical and/or audible features into the message.

### BACKGROUND

Mobile text-based messaging has existed for numerous years. For example, text messages that use the short message service (“SMS”) methods of communication are commonly provided on mobile phones. These messages, however, are often associated with additional fees (i.e., in addition to standard mobile phone charges for telephone calls), subject to quantity limitations (e.g., only 50 messages can be sent per month without being subjected to additional fees), and limited in size and format (e.g., 160 or less text-based characters). Therefore, SMS text messaging is often expensive and limited in capacity to express emotions or feelings in a message.

### SUMMARY

Accordingly, embodiments of the invention provide systems and methods for creating, sending, and receiving messages that include graphical and/or audible features (e.g., without using SMS). In particular, embodiments of the present invention provide mobile text messaging with a library of audio-enabled emoticons. In one embodiment, the invention provides a system for texting that includes at least two software applications. A sender software application, executed at a computing device operated by the sender, allows the sender to select an emoticon and/or associated audio from a library of predefined emoticons and audio files to be included in a text-based message to a receiver (e.g., through a user interface displayed on the computing device). The sender software application adds one or more tags to the message associated with the emoticon and/or audio file selected by the sender. The sender software application then transmits the message to a server.

The server transmits a signal to a computing device operated by an intended receiver of the message that a message has been received for the receiver. The computing device operated by the receiver receives the signal and generates a notification. A receiver software application, executed at the computing device operated by the receiver, automatically intercepts the notification (before or after the computing device displays the notification to the receiver) and requests or otherwise receives the message from the server. The receiver software application contains a similar library to the library included in the sender software application. Therefore, the receiver software application identifies the emoticons and/or audio files associated with the message based on the tags in the message and displays the message and any emoticons and/or audio files to the receiver (e.g., through a user interface display on the computing device).

In particular, one embodiment of the invention provides a system for messaging. The system includes a first computing device that includes a first processor and first non-transitory computer-readable medium. The first computer-readable medium stores a first software application executable by the first processor to receive a selection of an audio-enabled emoticon from a first user, automatically insert at least one tag into a message wherein the at least one tag is associated with the selected audio-enabled emoticon, and transmit the message to a second computing device including a second processor and second non-transitory computer-readable medium. The second computer-readable medium stores a second software application executable by the second processor to translate the at least one tag into the selected audio-enabled emoticon and display the selected audio-enabled emoticon as part of the message to a second user.

Another embodiment of the invention provides a method for messaging. The method includes receiving, by a first computing device, a selection of an audio-enabled emoticon from a first user and automatically, by the first computing device, inserting at least one tag into a message, the at least one tag associated with the selected audio-enabled emoticon. The method further includes transmitting, by the first computing device, the message to at least one second computing device over at least one wireless network, the at least one second computing device configured to translate the at least one tag into the audio-enabled emoticon and display the audio-enabled emoticon as part of the message to a second user.

Yet another embodiment of the invention provides another method for messaging. The method includes receiving, by a first computing device, a message including at least one tag and automatically, by the first computing device, translating the at least one tag into an audio-enabled emoticon. The method also includes displaying the audio-enabled emoticon to a user on the first computing device.

Other aspects of the invention will become apparent by consideration of the detailed description and accompanying drawings.

### BRIEF DESCRIPTION OF THE DRAWINGS

FIG. 1 schematically illustrates a system for creating, sending, and receiving messages.

FIG. 2 is a flow chart illustrating a method of messaging using the system of FIG. 1.

FIG. 3 is a screen shot illustrating a user interface displaying current conversations or message exchanges.

FIG. 4 is a screen shot illustrating a user interface for creating a new message.

FIG. 5 is a screen shot illustrating a user interface for selecting graphical and audio features for a message.

### DETAILED DESCRIPTION

Before any embodiments of the invention are explained in detail, it is to be understood that the invention is not limited in its application to the details of construction and the arrangement of components set forth in the following description or illustrated in the accompanying drawings. Specific configurations illustrated in the drawings are intended to exemplify embodiments of the invention, and other alternative configurations are possible. In particular, the invention is capable of other embodiments and of being practiced or of being carried out in various ways. Also, it is to be understood that the phraseology and terminology used herein is for the purpose of description and should not be regarded as limiting. The use of “including,” “comprising” or “having” and variations thereof herein is meant to encompass the items listed thereafter and equivalents thereof as well as additional items. Also, the terms “mounted,” “connected” and “coupled” are used broadly and encompass both direct and indirect mounting, connecting and coupling. Further, “connected” and “coupled” are not restricted to physical or mechanical connections or couplings, and can include electrical connections or couplings, whether direct or indirect. Also, electronic communications and notifications may be performed using any known means including direct connections, wireless connections, etc.

In should also be understood that the invention can be implemented using various computing devices (e.g., smart telephones, personal computers, tablet computers, desktop computers, smart televisions, etc.) that have processors that are capable of executing programs or sets of instructions. In general, the invention may be implemented using existing hardware or hardware that could be readily created by those of ordinary skill in the art. Thus, the architecture of exemplary devices will not be explained in detail, except to note that the computing devices will generally have one or more processors, non-transitory memory modules (e.g., RAM or ROM), and input and output devices or interfaces. In some cases, the computing devices may also have operating systems and application programs that are managed by the operating systems. The computing devices can also communicate over one or more networks, such as the Internet.

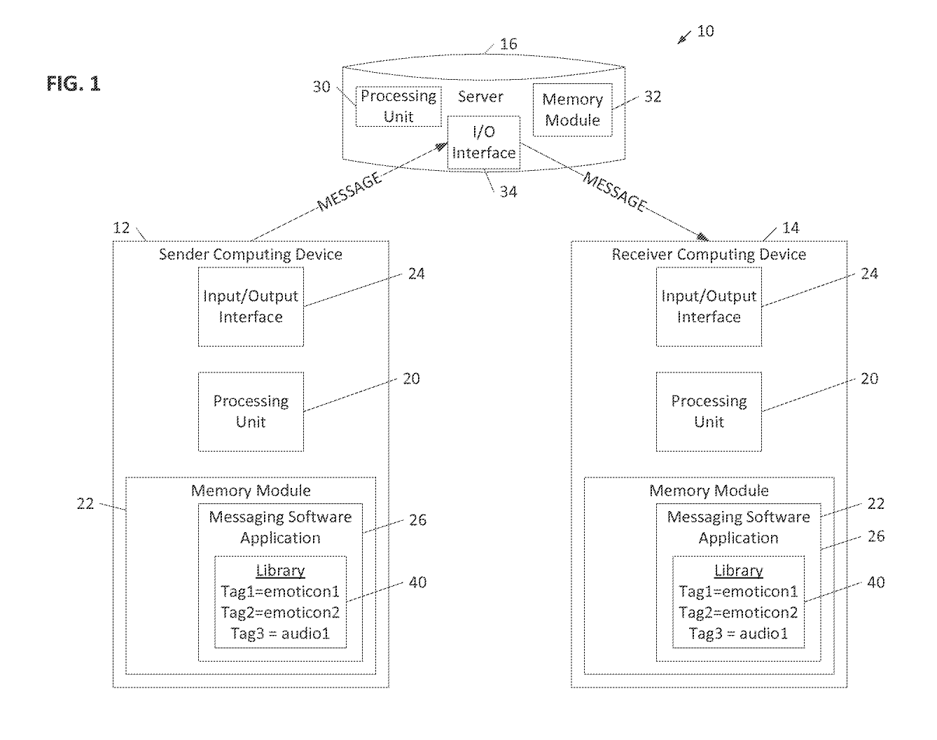

FIG. 1 illustrates a system 10 for creating, sending, and receiving messages that include emoticons and/or audio data. As illustrated in FIG. 1, the system 10 includes a sender computing device 12 and a receiver computing device 14. The sender and receiver computing devices 12, 14 communicate with a server 16. It should be understood that although only a single sender computing device 12 and a single receiver computing device 14 are illustrated in FIG. 1, the system 10 can include multiple computing devices used by senders and/or receivers. Similarly, in some embodiments, the system 10 includes multiple servers communicating with the computing devices.

The computing devices 12, 14 can include a smart telephone, a table computer, a laptop computer, a desktop computer, a smart television, etc. The computing devices 12, 14 may each be configured in a number of different ways and may each include a processing unit 20 (e.g., a microprocessor, an application specific integrated circuit (“ASIC”), etc.), one or more memory modules 22, and an input/output interface 24. The memory modules 24 include non-transitory computer-readable medium, such as random-access memory (“RAM”) and/or read-only memory (“ROM”). The processing units 20 retrieve instructions from the respective memory modules and execute the instructions to perform particular functionality. The processing units 20 can also retrieve and store data to the respective memory modules as part of executing the instructions. For example, as illustrated in FIG. 1, the memory modules 22 of the computing devices 12, 14 each store a messaging software application 26 executable by the processing units 20. The processing units 20 also obtain data from external devices and systems (e.g., the server 16) through the input/output interfaces 24. For example, the input/output interfaces 24 of the computing devices 12, 14 can include a transceiver configured to wirelessly communicate with server 16.

The server 16 may be configured in a number of different ways and may include a processing unit 30 (e.g., a microprocessor, an application specific integrated circuit (“ASIC”), etc.), one or more memory modules 32, and an input/output interface 34. The memory module 32 includes non-transitory computer-readable medium, such as random-access memory (“RAM”) and/or read-only memory (“ROM”). The processing unit 30 retrieves instructions from the memory module 32 and executes the instructions to perform particular functionality. The processing unit 30 can also retrieve and store data to the memory module 32 as part of executing the instructions. For example, the memory module 32 of the server 16 can store a software application executable by the processing unit 32. As described in more detail below, the server 16 executes the software application 36 to receive messages transmitted by the messaging software application 26 executed by the sender computing device 12 and forward the messages to the messaging software application 26 executed by the receiver computing device 14.

It should also be understood that the computing devices and the server can include additional components than those described herein. Furthermore, in some embodiments, the functionality of the computing devices 12, 14 and the server 16 can be distributed in various configurations. Also, the functionality of the server can be distributed among multiple devices (e.g., multiple servers).

In some embodiments, the messaging software application 26 stored and executed on the sender computing device 12 performs the same functionality as the messaging software application 26 stored and executed on the receiver computing device 14. Accordingly, it should be understood that the functionality performed by the “messaging software application 26” described below can be performed on either the sender computing device 12 or the receiver computing device 14.

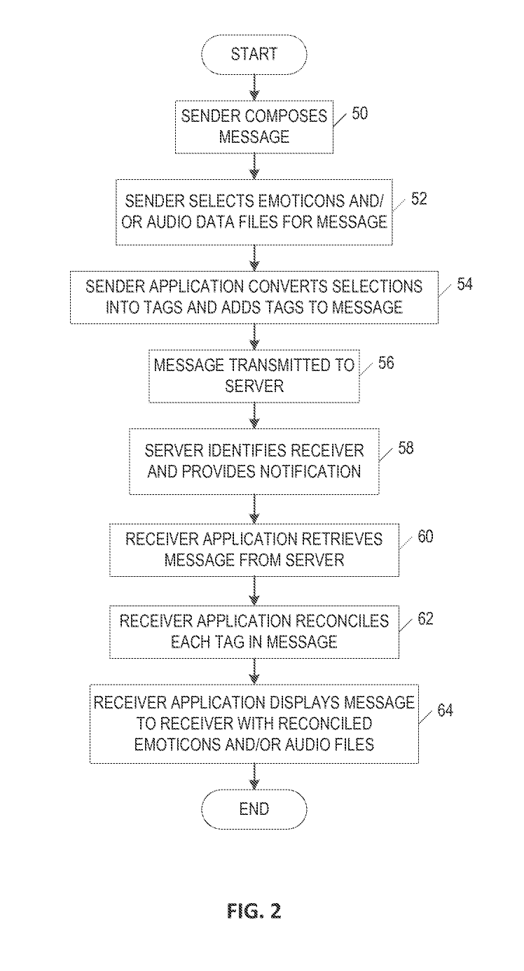

FIG. 2 illustrates a method of messaging using the system 10. As illustrated in FIG. 2, using the sender computing device 12, a sender can use the messaging software application 26 to compose a text-based message for at least one receiver (e.g., by typing text and selecting a receiver, such as from a list of contacts stored on the sender computing device 12) (at 50). The sender can also add one or more emoticons and/or audio data files to the message (at 52). For example, as illustrated in FIG. 1, the messaging software application 26 includes a library 40 that stores a plurality of emoticons and/or audio data files that can be added to a message. It should be understood that the term “emoticon” used in the present application includes any type of graphical icon regardless of whether the icon expresses a facial expression or emotion.

In some embodiments, the library 40 includes a preset number of emoticons and/or audio data files and users can download (e.g., for free or for a fee) additional emoticons and/or audio data files as desired (e.g., from the server). Each emoticon and audio data file can be associated with a predefined “tag” or other identifier. It should be understood that a tag stored in the library 40 can identify an individual emoticon, an individual audio file, a combination of emoticons, a combination of audio files, or a combination of one or more emoticons and one or more audio files. For example, in some embodiments, an emoticon can be associated with a particular audio file. These emoticons are referred to herein as audio-enabled emoticons.

Also, it should be understood that the library 40 stored on each computing device can vary based on those emoticons and/or audio files used or downloaded by a particular user. Therefore, in some embodiments, the library 40 stored on the sender computing device 12 is different than the library 40 stored on the receiver computing device. The server 16 can manage a database of all available emoticons and/or audio files. The database can be stored on the server 16 (e.g., in the memory module 32) or a separate data storage device. The database includes a list of unique tags and associates one or more emoticons and/or one or more audio data files with each unique tag.

Therefore, to add an emoticon and/or an audio data file to the message, the sender can select a particular emoticon and/or audio data file from the library 40. In some embodiments, the sender can also select a particular emoticon and/or audio data file from the database maintained by the server 16. Upon selecting a particular emoticon and/or audio data file from the database, the messaging software application 26 can automatically download the selected emoticon and/or audio data file and associated unique tag from the database and add the downloaded information to the library 40 if the library 40 does not already include the selection.

The messaging software application 26 converts the selected emoticon and/or audio data file to a tag (at 54, FIG. 2). In particular, the application 26 identifies the unique tag associated with the selection using the library 40 or the database maintained by the server 16) and adds the tag to the message. The messaging software application 26 executed by the sender computing device 12 then transmits the message to the receiver computing device 14. In some embodiments, rather than sending the message as a SMS text message, the application 26 transmits a message to the server 16 (at 56). The application 26 can transmit the message to the server 16 using the cellular network or a non-cellular network, such as the Internet (e.g., using a Wi-Fi connection). In some embodiments, the messaging software application 26 and the server 16 use various levels of encryption and other security measures to protect messages from improper interception or manipulation.

Upon receiving a message, the server 16 uses information regarding the receiver of the message (i.e., included as part of the message received from the sender computing device 12) to send a signal or notification to the receiver computing device 14 (at 58). The signal informs the receiver computing device 14 that a message is available for download or access through the server 16. In some embodiments, the signal acts as a notification similar to signals generated by other mobile applications, such as gaming applications. The receiver computing device 14 can be configured to generate a notification and display or provide the notification to the receiver (e.g., via a banner, a pop-up screen, a chime or other tone, a vibration sequence, etc.). The messaging software application 26 executed by the receiver computing device 14 can also be configured to intercept the notification (either before, concurrently, or after the notification is displayed or otherwise provided to the receiver) and access the server 16 to retrieve the message (at 60). In other embodiments, the server 16 can be configured to automatically push the message directly to the receiver computing device 14 rather than or in addition to providing the notification signal.

After retrieving the message, the messaging software application 26 executed by the receiver computing device identifies any tags included in the message and reconciles or translates the tags to particular emoticons and/or audio files (at 62). In particular, using an opposite functionality as performed by the application 26 executed by the sender computing device 12, the application 26 executed by the receiver computing device 15 uses the library 40 and/or the database maintained by the server 16 to identity what emoticons and/or audio files are associated with the tag included in the received message. If the application 26 determines that the library 40 stored on the receiver computing device 14 includes the tag included in the message, the application 26 adds the emoticons and/or audio data files stored in the library 40 associated with the tag to the message. Alternatively, if the library 40 does not include the tag included in the message, the application 26 accesses the database maintained by the server 16 and downloads the associated emoticons and/or audio data files. Also, in some embodiments, the application 26 accesses the database even when the library 40 includes the tag included in the message to obtain any updates or changes that may have been made to the associated emoticons and/or audio data files. In some embodiments, if the application 26 downloads emoticons and/or audio data files from the database as part of translating a received message, the receiver can be charged for any downloaded data associated with fees. In other embodiments, the sender is charged for the downloaded data.

The message software application 26 executed by the receiver computing device 14 then displays the message with the reconciled emoticons and/or audio data files (in place of or in addition to displaying the tags in the text-based message) (at 64). As used in the present application, “displaying” the message to a receiver includes displaying the text-based message, displaying any emoticons included in the message, and playing any audio data files included in the message. As described in more detail below, “displaying” also includes playing the audio data file associated with the message before displaying the message to the receiver to inform the receiver that the message was received.

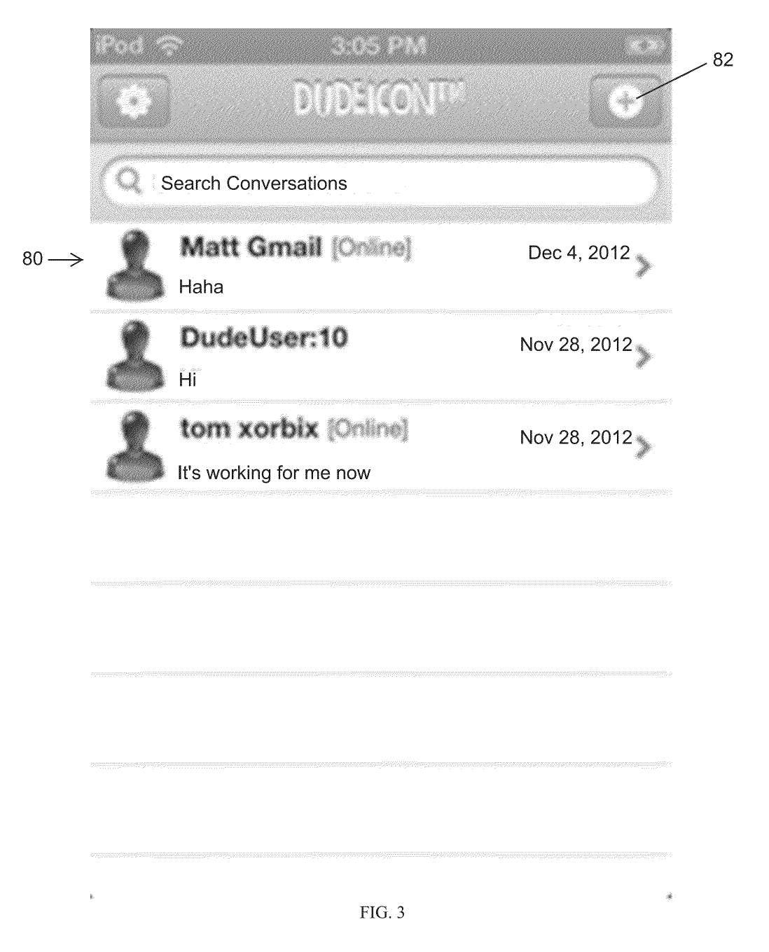

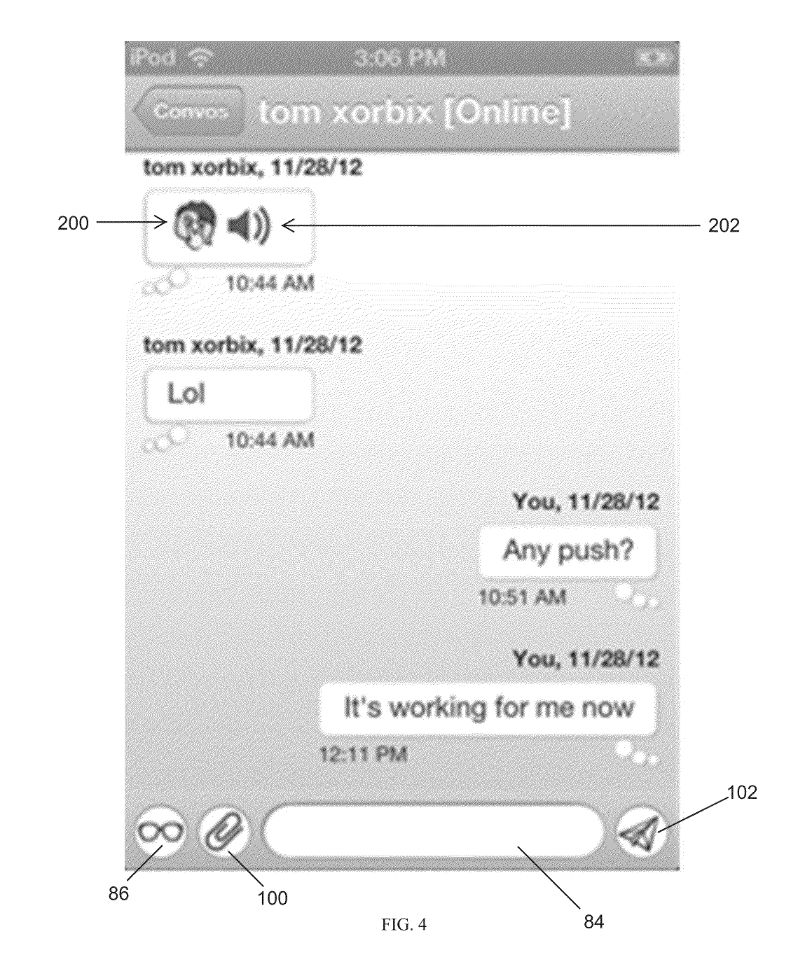

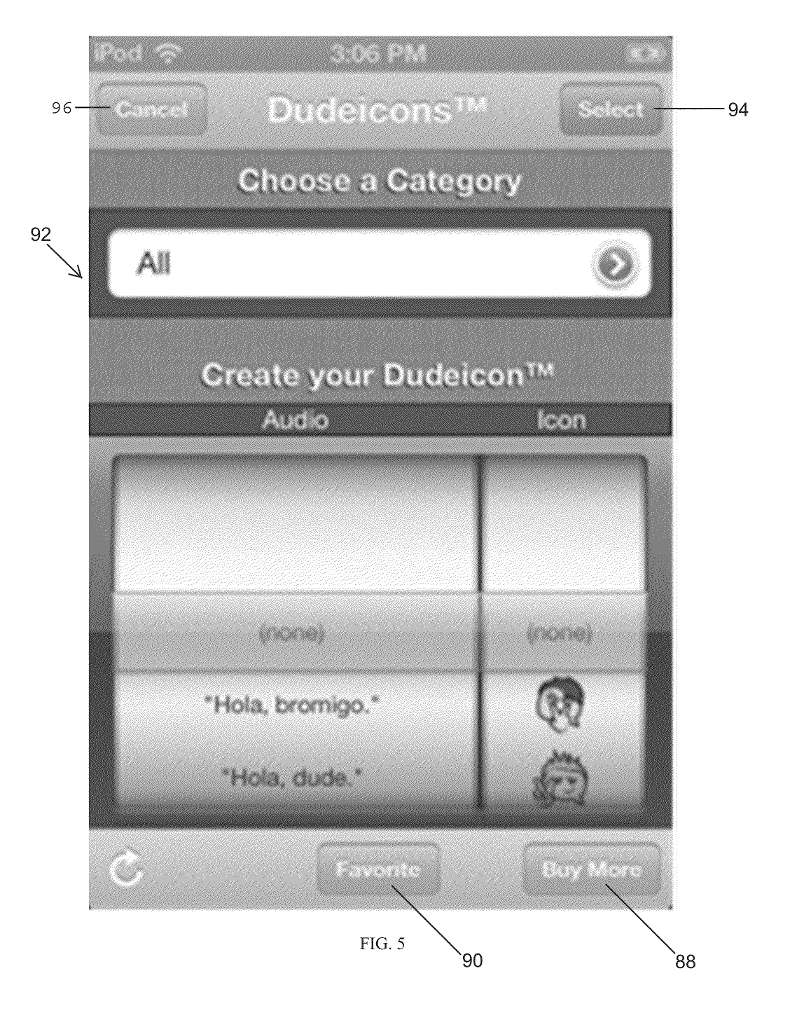

FIGS. 3-5 are screen shots of an example graphical user interfaces generated by the messaging software application 26. As illustrated in FIG. 3, the messaging software application 26 can display a list 80 of recent conversations or messages sent or received. The messaging software application 26 can also allow a user to create a new message (e.g., by selecting a new icon 82 in FIG. 3 or typing text into an input mechanism 84 displayed as part of an existing conversation in FIG. 4). For example, as illustrated in FIG. 4, the user interface can display an emoticon icon 86 (e.g., a sunglasses icon) that a sender can select to access the library 40 of emoticons and/or audio data files. FIG. 5 illustrates the user interface displaying the library 40 to the sender. In some embodiments, the user interface illustrated in FIG. 5 allows a sender can select an individual emoticon, multiple emoticons, an individual audio data file, multiple audio data files, or a combination of one or more emoticons and one or more audio data files (i.e., an audio-enabled emoticon). By allowing a sender to select an emoticon and an audio data file independently, the sender can create customized combinations of graphics and audio for a particular message. As illustrated in FIG. 5, a sender can also obtain more emoticons and/or audio data files from the server 16 by selecting a “Buy More” icon 88. In some embodiments, a sender can also mark particular emoticons and/or audio data files as “favorites,” by selecting a “Favorite” icon 90. Furthermore, to sort available emoticons and/or audio data files (e.g., by predefined categories), a sender can select a particular category from a category selection mechanism 92. After a sender selects one or more emoticons and/or audio data files, the sender can select a “Select” icon 94 to confirm his or her selections. Alternatively, a sender can select a “Cancel” icon 96 to return to the message without selecting any emoticons and/or audio data files.

In some embodiments, as illustrated in FIG. 4, the messaging software application 26 also allows a sender to attach other items to the message, such as an image, by selecting a paperclip icon 100. As also illustrated in FIG. 4, after typing a desired text-message and selecting any desired emoticons and/or audio files (and, optionally, other attachments), the sender can select a send icon 102 (e.g., a paper airplane icon) to send the message.

As illustrated in FIG. 4, when a receiver receives a message including an emoticon and/or an audio file, the emoticon 200 is displayed with the message and the audio data file is played when the receiver opens or accesses the message. Alternatively or in combination, the messaging software application 26 can play an audio data file associated with a message before the receiver opens or accesses the message, such as to alert the receiver that a message has been received (e.g., like a ringer, chime, or other tone played to alert a user to a received call, message, or text). In some embodiments, the receiver can change settings associated with the messaging software application 26 to turn on and off this “alert” audio feature.

In some embodiments, the receiver can also select (e.g., touch, click-on, etc.) the emoticon 200 itself or an icon representing the audio data file associated with a message (e.g., the icon 202) to play the audio data file again (or initially). It should be understood that the emoticons can also include animation. Therefore, in some embodiments, a receiver can similarly select (e.g., touch, click-on, etc.) the emoticon 200 or a separate icon to replay the emoticon animation. Similar icons and functionality can be provided to the sender when the sender is selecting emoticons and audio data files from the library or otherwise composing a new message or viewing a previously-sent message.

In some embodiments, the audio data files available for insertion into a message can be created to apply to any receiver. For example, rather than using gender-specific pronouns, the audio data files can use a gender-neutral term, such as “Dude.” Also, in some embodiments, the audio data files can be created by celebrities with recognizable voices. Furthermore, in some embodiments, the message software application 26 is configured to add customized audio to the audio data file (e.g., based on the sender or receiver of the message). For example, the messaging software application 26 can be configured to add a name of the sender or receiver of the message at a designated location within the audio file (e.g., “Dude, it's [insert name].”). The messaging software application 26 can use known voice generation software to insert the audio. In some embodiments, the messaging software application 26 uses different voice generation features to match the inserted audio to the original voice in the audio data file (e.g., to make the inserted audio blend better with the other stored audio data file). In other embodiments, a sender can generate recordings that provide the inserted audio in their own voice. If the sender creates specialized recordings, the recordings can be transmitted with the message.

In addition to the messaging functionality described above for the messaging software application 26, the application 26 can be configured to provide other features. For example, in some embodiments, the messaging software application 26 allows a user to turn on and configure a notification feature that automatically responds to received messages when the user is unavailable, such as when the user is driving. In particular, a user can select a particular message (e.g., including a particular emoticon and/or audio data file) that will be automatically sent in reply to any messages sent to the user while the user is unavailable. Similarly, a user can configure the application to automatically send a message when the user is available again (e.g., is safely off the road). For example, if a user received a message while driving, the messaging software application 26 can be configured to automatically send a message indicating that the user is unavailable and/or to automatically send a message indicating that the user is available after the user turns off the notification feature. The automatic notification feature can be used to prevent driving and texting, which is a major cause of car accidents. The automatic message sent by the notification feature can also encourage the receipt of the automatic message to avoid driving and texting, which adds to a wider campaign against dangerous driving and texting.

In some embodiments, the messaging software application 26 also allows a user to become a part of various groups or “nations” defined by the message software application 26 to receive messages with news about specific bands, performances, games, sports teams, etc. A user's groups can also be used by the messaging software application 26 to target application features or advertising to the user. Furthermore, in some embodiments, the messaging software application 26 is configured to allow users to purchase items (e.g., DVDs, concert tickets, clothing, skateboard accessories, computer peripherals, etc.) through messages or other advertising provided through the software application 26 (e.g., directly or through links to websites).

The messaging software application 26 can also be configured to allow users to create and submit custom emoticons and/or audio data files. The custom emoticons and/or audio data files can be submitted to particular receivers (e.g., designated by the user who created the customizations—referred to herein as the “creator”) or may be offered globally to any users through a license from the creators. Any fees collected from the customizations can be shared with the creator. In other embodiments, the customizations can be added to the database maintained by the server 16, where users can view and download desired emoticons and/or audio data files (e.g., for free or for a fee). As described above, if a receiver receives a message that includes an emoticon and/or a data file that is not part of its library 40, the message software application 26 can be configured to automatically (or at the confirmation of the receiver) download the necessary data (e.g., for free or for a fee) to display the message. In some embodiments, the application 26 can be configured to prompt the receiver to confirm the download before the application 26 downloads emoticons and/or audio data files associated with a particular received message.

In some embodiments, particular emoticons and/or audio data files can be offered in connection with particular charities. For example, celebrities can record data files and create custom emoticons (i.e., custom audio-enabled emoticons) that are available for download from the database for a fee wherein at least a portion of the fee is provided to a designated charity (e.g., a charity selected by or associated with the celebrity creating the custom audio-enabled emoticon). For example, the database maintained by the server 12 can store a flag for each unique tag that indicates whether the tag is associated with a free emoticon and/or audio data file or a fee-based emoticon and/or audio data file. If the tag is fee-based, the database can also store account information associated with the fee that indicates where collected fees should be credited. In some embodiments, the account information can be used as the flag (e.g., if the account information is null or empty, the tag is free). In some systems, the account information specifies an account with the server 16, an unrelated account (such as at a financial institution), an online account (such as PayPal™), or a particular organization or charity. The database can also store a percentage value associated with the account information. The percentage value indicates a share of the collected fees that should be credited to the account specified by the account information. It should be understood that each tag can be associated with multiple account-percentage-value pairs (e.g., if collected fees are distributed among multiple accounts). Accordingly, collected fees for a particular tag can be distributed between the celebrity who created the emoticon and/or audio data files and a charity selected by the celebrity. In some instances, if a percentage of collected fees are credited to a charity, text is automatically added to the message (e.g., at the end) indicating that a charitable donation was made through purchase of the data associated with the message (e.g., an emoticon and/or an audio file).

Emoticons and/or audio files may also be offered as packages (e.g., packages associated with common messages for females, males, or teenagers, or packages associated with particular celebrities, movies, sports teams, bands, etc.). The packages can include a set of audio files with various audio messages (e.g., “Dude, it's [name], please text Dave right now!” or “Dude, it's [name], Megan's chilling, she'll get back to you later.”).

As noted above, the messaging software application 26 can be configured to provide advertising. The advertising could be displayed along with messages. In other embodiments, the advertising can be embedded in messages. For example, an alcohol company could sponsor a public service announcement as part of a drink responsibly campaign that sends a message with custom emoticons and/or audio files to designated users. Similarly, movie and music companies could promote new releases in messages with custom material (e.g., an audio clip from a movie with a “dude” reference). Other industries, such as skateboarding, surfing, technology industries, etc., could also transmit messages to release information about new products, events, etc.

It should be understood that although the present invention is described with respect to (and provides particular advantages in connection with) text-based messaging through a web-based service, the functionality described above can be used on any platform or communication network (including SMS) and any type of data or message transmitted between computing devices. Also, in some embodiments, the emoticon and/or audio file can be directly embedded in the message rather than using the tags as described above.

Various features and aspects of the invention are set forth in the following claims.

What is claimed is:

1. A system for messaging comprising:
a first computing device including a first processor and first non-transitory computer-readable medium, the first computer-readable medium storing a first software application executable by the first processor to receive a selection of an audio-enabled emoticon from a first user, automatically insert at least one tag into a message wherein the at least one tag is associated with the selected audio-enabled emoticon, and transmit the message to a second computing device including a second processor and second non-transitory computer-readable medium, the second computer-readable medium storing a second software application executable by the second processor to translate the at least one tag into the selected audio-enabled emoticon and display the selected audio-enabled emoticon as part of the message to a second user.

2. The system of claim 1, wherein the computer-readable medium stores a plurality of audio-enabled emoticons and a unique tag associated with each of the plurality of audio-enabled emoticons and wherein the selection includes one of the plurality of audio-enabled emoticons.

3. The system of claim 1, further comprising a server accessible to the first computing device and the second computing device over at least one wireless network, wherein the server stores a plurality of audio-enabled emoticons and a unique tag associated with each of the plurality of audio-enabled emoticons and wherein the selection includes one of the plurality of audio-enabled emoticons.

4. The system of claim 1, further comprising the second computing device.

5. The system of claim 4, wherein the second software application is executable by the second processor to translate the at least one tag into the selected audio-enabled emoticon by accessing a plurality of audio-enabled emoticons stored by a server and downloading the selected audio-enabled emoticon from the server.

6. The system of claim 4, wherein the audio-enabled emoticon is associated with a graphical icon and an audio data file and wherein the second software application is executable by the second processor to display the audio-enabled emoticon by displaying the graphical icon and playing the audio data file.

7. The system of claim 4, wherein the second software application is executable by the second processor to display the audio-enabled emoticon by playing the audio data file before display the graphical icon to notify a receiver that the message was received.

8. The system of claim 1, wherein the first software application is executable by the first processor to automatically charge the first user a fee based on the selected audio-enabled emoticon, wherein at least a portion of the fee is provided to a charity.

9. The system of claim 1, wherein the first software application is executable by the first processor to automatically send a predetermined message in response to a received message, wherein the predetermined message informs a sender of the received message that the first user is unavailable to respond to the received message.

10. The system of claim 9, wherein the first software application is executable by the first processor to receive an indication from the first user to start automatically sending the predetermined message.

11. The system of claim 9, wherein the first software application is executable by the first processor to receive an indication from the first user to stop automatically sending the predetermined message.

12. The system of claim 11, wherein the first software application is executable by the first processor to automatically send a second predetermined message after receiving the indication from the first user to stop automatically sending the first predetermined message, wherein the second predetermined message informs a sender of the first predetermined message that the first user is available to respond to messages.

13. A method of messaging comprising:
receiving, by a first computing device, a selection of an audio-enabled emoticon from a first user;
automatically, by the first computing device, inserting at least one tag into a message, the at least one tag associated with the selected audio-enabled emoticon; and
transmitting, by the first computing device, the message to at least one second computing device over at least one wireless network, the at least one second computing device configured to translate the at least one tag into the audio-enabled emoticon and display the audio-enabled emoticon as part of the message to a second user.

14. The method of claim 13, further comprising storing a plurality of audio-enabled emoticons and a unique tag associated with each of the plurality of audio-enabled emoticons on the first device and displaying the plurality of audio-enabled emoticons to the first user.

15. The method of claim 14, wherein receiving the selection includes receiving a selection of one of the plurality of audio-enabled emoticons and automatically inserting the at least one tag into the message includes automatically inserting the unique tag associated with the selected one of the plurality of audio-enabled emoticons stored on the first computing device into the message.

16. The method of claim 13, further comprising accessing a plurality of audio-enabled emoticons and a unique tag associated with each of the plurality of audio-enabled emoticons stored on a server and displaying the plurality of audio-enabled emoticons to the first user.

17. The method of claim 16, wherein receiving the selection includes receiving a selection of one of the plurality of audio-enabled emoticons and automatically downloading the one of the plurality of audio-enabled emoticons and the associated unique tag from the server to the first computing device.

18. The method of claim 17, wherein automatically inserting the at least one tag into the message includes automatically inserting the downloaded unique tag into the message.

19. The method of claim 13, further comprising automatically charging the first user a fee based on the selection, wherein at least a portion of the fee is provided to the charity.

20. The method of claim 19, further comprising automatically adding text to the message identifying the charity.

21. The method of claim 13, further comprising automatically sending a predetermined message in response to a received message, wherein the predetermined message informs a sender of the received message that the first user is unavailable to respond to the received message.

22. The method of claim 21, further comprising receiving an indication from the first user to start automatically sending the predetermined message.

23. The method of claim 21, further comprising receiving an indication from the first user to stop automatically sending the predetermined message.

24. The method of claim 23, further comprising automatically sending a second predetermined message after receiving the indication from the first user to stop automatically sending the first predetermined message, wherein the second predetermined message informs a sender of the received message that the first user is able to respond to messages.

25. The method of claim 13, wherein transmitting the message to the at least one second computing device includes transmitting the message to a server, wherein the server is configured to forward the message to the at least one second computing device over at least one wireless network.

26. A method of messaging comprising:
receiving, by a first computing device, a message including at least one tag;
automatically, by the first computing device, translating the at least one tag into an audio-enabled emoticon; and
displaying, the first computing device, the audio-enabled emoticon to a user.

27. The method of claim 26, wherein automatically translating the at least one tag includes accessing a plurality of audio-enabled emoticons stored on the first computing device, wherein each of the plurality of audio-enabled emoticons is associated with a unique tag, and identifying the one of the plurality of audio-enabled emoticons associated with a unique tag matching the at least one tag.

28. The method of claim 26, wherein automatically translating the at least one tag includes:
accessing a plurality of audio-enabled emoticons stored on a server, wherein each of the plurality of audio-enabled emoticons is associated with a unique tag,
identifying the one of the plurality of audio-enabled emoticons associated with a unique tag matching the at least one tag, and
downloading the one of the plurality of audio-enabled emoticons from the server to the first computing device.

29. The method of claim 26, wherein displaying the audio-enabled emoticon to the user includes playing an audio data file associated with the audio-enabled emoticon to before displaying the message to the user to inform the user that the message was received.

30. The method of claim 26, wherein displaying the audio-enabled emoticon to the user includes playing an audio data file associated with the audio-enabled emoticon and displaying a graphical icon associated with the audio-enabled emoticon to the user with the message.

31. The method of claim 26, further comprising automatically sending a predetermined message in response to the message, wherein the predetermined message informs a sender of the message that the user is unavailable to respond to the received message.

32. The method of claim 31, further comprising receiving an indication from the user to start automatically sending the predetermined message.

33. The method of claim 31, further comprising receiving an indication from the user to stop automatically sending the predetermined message.

37. The method of claim 33, further comprising automatically sending a second predetermined message after receiving the indication from the user to stop automatically sending the first predetermined message, wherein the second predetermined message informs a sender of the message that the user is able to respond to messages.
